(19) United States
(12) Patent Application Publication
(10) Pub. No.: US 2015/0280572 A1
(43) Pub. Date: Oct. 1, 2015

(54) NON-RESONANT ZERO CURRENT MULTIPLE-OUTPUT POWER CONVERTER

(71) Applicant: Alcatel-Lucent Canada, Inc., Ottawa (CA)

(72) Inventor: Martin PLESNIK, Ottawa (CA)

(73) Assignee: Alcatel-Lucent Canada, Inc., Ottawa (CA)

(21) Appl. No.: 14/242,307

(22) Filed: Apr. 1, 2014

(51) Int. Cl. H02M 3/335

(52) U.S. Cl. CPC H02M 3/33507

(57) ABSTRACT

Various exemplary embodiments relate to a power conversion device, including an input configured to receive input power, a first-stage circuit connected to the input configured to provide galvanic isolation between the input and a second-stage circuit, wherein the first-stage circuit comprises at least one first-stage power conversion unit, each first-stage power conversion unit including at least two primary switches, at least two secondary transistor switches, and an isolation transformer including a primary winding and a secondary winding, the second-stage circuit connected to an output of the first-stage circuit, the second-stage circuit comprising at least one second-stage power conversion unit configured to regulate the voltage to at least one output connected to a load, each at least one second-stage power conversion unit comprising a controller, a master circuit connected to the at least one controller, the master circuit configured to synchronize switching in the at least one second-stage power conversion unit, and where the master circuit is configured to drive the primary switches and the secondary transistor switches in the at least one first-stage power conversion unit.

### TECHNICAL FIELD

Various exemplary embodiments disclosed herein relate generally to non-resonant zero current switching for power conversion.

### BACKGROUND

Power supplies transfer power from a source to a load, typically a hardware application such as a computer or communications equipment, while converting voltage and current characteristics. High-frequency power supplies such as a switched-mode power supplies facilitate conversion of current for hardware applications that demand high power at greater efficiency and smaller footprint than is possible from linear power supplies. As the features and demands of hardware applications increase, so does the load, e.g., more power is needed. In part due to increased power demands, green technology requests, and increased cooling requirements from equipment buyers, manufacturers of power converters have targeted the development of power converters that operate with as high power conversion efficiency as possible while reducing power loss, converter overall costs, and size. For most applications such as the telecommunications industry, it is also necessary that the power converter satisfies electromagnetic interference (EMI) emissions requirements.

Conventional switching power converters use two major techniques to control the switching time with respect to the voltage across the switch and/or current through the switch: hard-switching and soft-switching. With hard-switching, the switching instant is not determined by voltage across the switch and/or current through the switch. With soft-switching converters, however, switching occurs when voltage across the switch and/or current through the switch is zero or very close to zero. Consequently, power losses associated with switching as well as Electro-magnetic Interference (EMI) emission can be substantially eliminated while overall power converter size, heat generated by the power converter, and other costs may be reduced. Due to these benefits, soft-switching converters are frequently used to power high-demand applications.

There are currently two major types of soft switching methods: zero current switching and zero-voltage switching. With both methods, a resonant tank is added to the switching converter circuit. This resonant tank usually consists of a capacitor and inductor.

During the converter switching period, the current and voltage in the resonant tank have sinusoidal shape. Converter switching is initiated when the magnitude of the current flowing through switching devices or the voltage across the switching devices is zero or very close to zero. Therefore, power losses on switching devices are substantially reduced leading to higher power conversion efficiency in the converter. One advantage to soft switching methods is that physically smaller and cost effective switching devices can be used. Also, these methods result in a reduction of EMI emissions, an inherit advantage in, for example, telecommunications applications.

Unfortunately, contemporary soft switching methods suffer from several problems. First, it is difficult to achieve zero current and/or zero voltage transitions at all operating conditions. For example, with certain combinations of input voltage, load current, and output voltage magnitude, zero current and/or zero voltage switching cannot be achieved. Consequential adjustments to the design of the converter to ensure that switching devices do not overheat generally result in the loss of the advantages of the resonant switching.

Second, due to the sinusoidal nature of the voltage and current in the resonant tank, the peak values of the resonant voltage and resonant current can be significant. Unfortunately, implementation of the devices capable of handling higher current and higher voltages necessarily lead to higher losses which are associated with their operation, which negatively affects converter design because: i) high peak currents and high peak voltages require higher current and higher voltage rated semiconductor switching devices having less desirable parameters, e.g. because voltage forward drop is bigger with higher voltage rated diodes, or drain-to-source resistance is higher with higher voltage rated switching transistors, ii) high currents cause increased conduction losses, and iii) high peak currents require using magnetic devices with significantly high saturation currents which, in turn, leads to use of either physically larger devices or higher magnetization losses, or both.

Third, the on-time period of the resonant converter, i.e. time interval during which the current enters the switching power converter, is typically maintained at a constant rate. Consequently, the converter output voltage regulation is achieved by controlling the switching period. However, this leads to variations of converter switching frequency which may be not desired in some applications. Also, options for converter controllers available on the market are substantially narrowed compared to hard-switching converters.

In view of the foregoing, it would be desirable to have a converter which would take advantage of soft switching but would not suffer from the drawbacks described above.

### SUMMARY

In light of the present need for a converter in which switching at zero current or zero voltage would be reliably guaranteed over all operating conditions while not exhibiting high peaks of voltages and currents, in which its switching frequency would not change, and which would take advantage of soft switching but would not suffer from the drawbacks described above, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a power conversion device including an input configured to receive input power, a first-stage circuit connected to the input configured to provide galvanic isolation between the input and a second-stage circuit, wherein the first-stage circuit includes at least one first-stage power conversion unit, each first-stage power conversion unit including at least two primary switches, at least two secondary diode switches, and an isolation transformer including a primary winding and a secondary winding; a second-stage circuit connected to an output of the first-stage circuit, the second-stage circuit including at least one second-stage power conversion unit configured to regulate the voltage to at least one output connected to a load, each at least one second-stage power conversion unit including a controller; a master circuit connected to the at least one controller, the master circuit configured to synchronize switching in the at least one second-stage power conversion unit; and wherein the master circuit is configured to drive the primary switches in the at least one first-stage power conversion unit.

In an alternative embodiment, a power conversion device includes an input configured to receive input power, a first-stage circuit connected to the input configured to provide galvanic isolation between the input and a second-stage circuit, wherein the first-stage circuit includes at least one first-stage power conversion unit, each first-stage power conversion unit including at least two primary switches, at least two secondary transistor switches, and an isolation transformer including a primary winding and a secondary winding; a second-stage circuit connected to an output of the first-stage circuit, the second-stage circuit including at least one second-stage power conversion unit configured to regulate the voltage to at least one output connected to a load, each at least one second-stage power conversion unit including a controller; a master circuit connected to the at least one controller, the master circuit configured to synchronize switching in the at least one second-stage power conversion unit; and wherein the master circuit is configured to drive the primary switches and the secondary transistor switches in the at least one first-stage power conversion unit.

In another alternative embodiment of the invention, a power conversion device includes an input configured to receive input power; a first-stage circuit connected to the input configured to provide galvanic isolation between the input and a second-stage circuit, wherein the first-stage circuit including at least one first-stage power conversion unit, each first-stage power conversion unit including at least two primary switches, at least two secondary diode switches, and an isolation transformer including a primary winding and a secondary winding; a second-stage circuit connected to an output of the first-stage circuit, the second-stage circuit including at least one second-stage power conversion unit; a master circuit connected to the at least one second-stage power conversion unit, the master circuit configured to drive the second-stage switches and regulate the output of the at least one second-stage power conversion unit; and wherein the master circuit is configured to drive the primary switches in the at least one first-stage power conversion unit.

In a further alternative embodiment, each of the at least one second-stage power conversion unit is one of a buck converter and boost converter. In another alternative embodiment, each of the at least one first-stage power conversion unit is one of a push-pull converter, full-bridge converter, and half-bridge converter. In yet another alternative embodiment, the master circuit is configured to switch the second-stage power conversion units such that the first-stage load current is an essentially continuous waveform having a period.

In other alternative embodiments of the invention, the master circuit is configured to switch the second-stage power conversion units such that the first-stage load current includes intervals where the load current is essentially zero. In another alternative embodiment, the master circuit is configured to switch the second-stage power conversion units such that the first-stage load current includes intervals of substantial length where the first-stage load current is essentially zero.

In further alternative embodiments of the invention, the master circuit is ground referenced to either a primary side or a secondary side of the power conversion device.

In additional alternative embodiments, the isolation transformer provides either a step up or step down function.

It should be apparent that, in this manner, various exemplary embodiments enable non-resonant zero current switching for power conversion.

### BRIEF DESCRIPTION OF THE DRAWINGS

In order to better understand various exemplary embodiments, reference is made to the accompanying drawings, wherein:

FIG. 1 illustrates an exemplary conventional zero current switching converter;

FIG. 2 illustrates a visualization of conduction times and typical waveforms of the conventional zero current switching converter;

FIG. 3 illustrates an exemplary converter of the invention;

FIG. 4 illustrates an example of currents flowing in the second stage of a converter of the invention with continuous load current;

FIG. 5 illustrates an example of currents flowing in the first stage of a converter of the invention with continuous load current;

FIG. 6 illustrates a visualization of exemplary non-resonant zero current switching in a converter of the invention;

FIG. 7 illustrates a visualization of currents flowing in the converter first-stage with exemplary non-resonant zero current switching of the invention;

FIG. 8 illustrates a visualization of exemplary non-resonant zero current switching in a converter of the invention with extended zero current interval;

FIG. 9 illustrates a visualization of current flowing in the first stage of a converter of the invention with extended zero current interval;

FIG. 10 illustrates an example of currents flowing in the converter second-stage with undesirable poor switching coordination between power conversion units;

FIG. 11 illustrates an example of currents flowing in a converter first-stage with undesirable poor switching coordination between power conversion units;

FIG. 12 illustrates a variant of components of an exemplary converter of the invention using synchronous rectifiers;

FIG. 13 illustrates a variant of components of an exemplary converter of the invention with a Master control circuit executing regulation function.

### DETAILED DESCRIPTION

The embodiments described below address the problems of resonant switching, specifically zero current switching. Instead of using a resonant tank as is conventional, a power converter may be arranged in two stages while operation of switching devices within each stage as well as that between the stages is synchronized. This arrangement allows the disconnection of load current flowing in the second stage from the first stage. The first-stage switching devices change their status when the load current is disconnected from the first stage, i.e. the first-stage switching devices switch at zero current. The interconnection of circuits in the embodiments may result in coordinated switching, in particular, coordination of the switching frequencies and switching instants within and among first-stage and second-stage power conversion units.

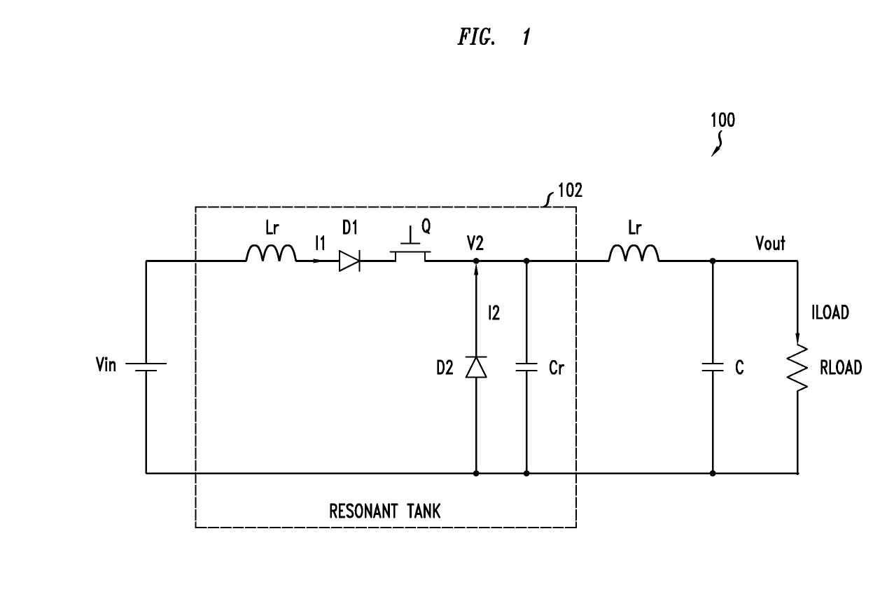

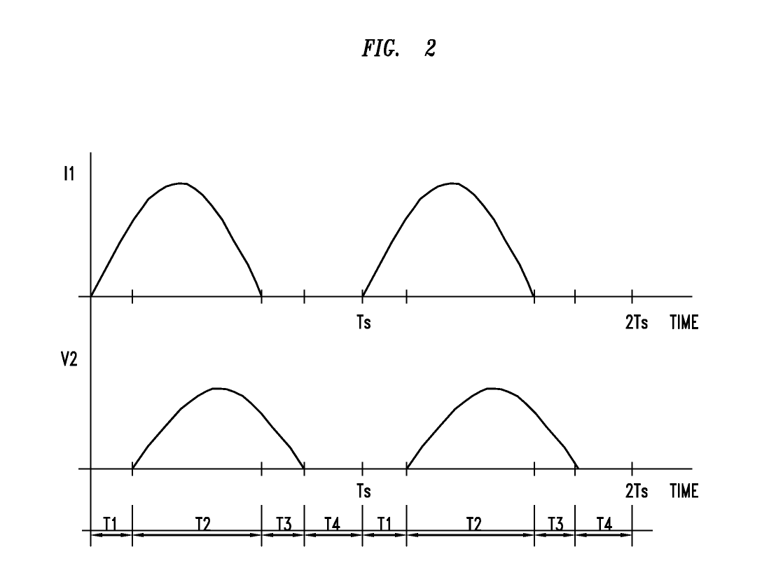

A typical prior art circuit 100 operating on the zero current switching principle is depicted in FIG. 1. This circuit converts a DC input voltage Vin to DC output voltage Vout. Inductor L and capacitor C create an output filter of this circuit. Load resistor RLoad is connected to the output developing a load current ILoad. Operation of this circuit is known for those skilled in the art and can be found in the literature. In this circuit 100, a resonant tank 102 consists of inductor Lr and capacitor Cr. Waveforms which correspond with operation of the resonant tank, specifically waveforms of the resonant inductor current I1 and resonant capacitor voltage V2 are shown in FIG. 2. In the steady-state, this circuit 100 operates in 4 topology changes within the converter switching cycle Ts. The switching cycle may be conceptually separated into 4 sub-intervals. At the beginning of the first sub-interval T1, current through the resonant inductor Lr and voltage across the capacitor Cr are equal to zero. The transistor Q is turned on and both diodes D1 and D2 are forward biased allowing current to flow through. While the diode D1 is turned on allowing current to flow into the inductor Lr, diode D2 operates in fly-wheeling mode delivering current to the converter load Rload. The current I1 grows while voltage V2 is close to zero. At the end of the first sub-interval T1, diode D2 becomes reverse-biased and, consequently, turns off. The converter then enters into the second topology. During the second sub-interval T2, diode D1 and transistor Q are on while diode D2 is off. Current continues to flow through the inductor Lr partially flowing to the inductor L and converter load Rload, and partially charging the resonant capacitor Cr. Current through the resonant inductor I1 and voltage across resonant capacitor V2 are of sinusoidal shape. Both of these waveforms reach peak and continue to decay to zero. At the time when the current through the resonant inductor Lr reaches zero, diode D1 becomes reverse-biased and stops conducting. At this time, the transistor Q may be turned off to achieve zero current switching. The converter 100 then enters the third topology. During the third sub-interval T3, all switching devices, transistor Q and diodes D1 and D2 are turned off. Voltage across the resonant capacitor V2 decreases to zero. At the time when voltage across the resonant capacitor V2 reaches zero, diode D2 is turned on. The converter then enters the fourth topology. During the fourth sub-interval T4, diode D2 conducts while transistor Q and diode D1 are turned off. After the fourth sub-interval expires, the transistor Q and diode D1 are turned on and converter switching repeats as described above.

In an embodiment of the invention, a multi-output power converter having a galvanic isolation between its primary and secondary sides consists of a first stage, second stage, and Master control circuit. The first stage consists of two power conversion units providing galvanic isolation. These power conversion units are connected in parallel, each unit including two branches to conduct current. The current flowing through the first stage is periodically straddled between two power conversion units as well as conduction branches such that each branch conducts current during an equal time, i.e. during 25% of the switching period. This arrangement has at least four advantages. First, the first-stage power conversion units allow a continuous current to flow from the converter input. Second, the conduction time of each current conduction branch is the same allowing for sharing the first-stage load current, and therefore also thermal stress, equally. Third, there is no risk of cross conduction as may happen when converters operate at a nearly 50% duty ratio. Fourth, the harmonic content of the transformer magnetizing current, and consequently a core loss caused by the magnetizing current spectrum, is smaller than the one which results from converter solutions operating with a nearly 50% duty ratio or with solutions using three or more parallel power conversion units operating in parallel.

In an alternative embodiment of the invention, the first stage includes only one power conversion unit providing galvanic isolation. In this arrangement, two paths exist conducting current during two equally spaced intervals, i.e. each path conducting current during, in an ideal case, 50% of the switching period. It should be apparent that while an arrangement lacking one power conversion unit (i.e. it includes two current branches only) is less complex and less costly at least in terms of the number of components required, at least the first, third and fourth advantages of the preferred solution described above are lost.

In an alternative embodiment of the invention, the first stage provides both galvanic isolation and step down or step up function.

The second stage consists of multiple power conversion units providing regulation functions. Each of the second-stage power conversion units operates in two or more topologies breaking this unit's switching cycle in two or more sub-intervals. During one sub-interval referred to here as on-time interval, a second-stage power conversion unit is connected to and therefore receives current from the first stage. Initialization of the on-time interval is controlled by the Master control circuit. Termination of the on-time interval is controlled by each second-stage power conversion unit such that the output voltage of this unit is maintained at a desired level. To provide such an output regulation function, the second-stage power conversion unit includes hardware to sense and regulate output voltage. There are alternative solutions for regulating output voltage of the second-stage power conversion units. For instance, this regulation function may be executed by the Master controller.

The Master control circuit generates switching control signals for the first-stage power conversion units as well as those for the second-stage power conversion units. There are two types of switching control signals which may be generated by the Master control circuit: synchronization signals and switch driving signals. Synchronization signals are used to initialize switching events. Switch driving signals are used to drive a particular switching device. While the switching control signals for the first-stage power conversion units are preferably equally spaced, alternatives for the second-stage power conversion units are possible including those described below.

The Master control circuit may include circuits which provide coupling between converter primary and secondary sides. The Master control function may be implemented in the form of a monolithic device (e.g. microprocessor or CPLD device), however various modifications using discrete devices and multiple controllers are possible.

Referring now to the drawings, in which like numerals refer to like components or steps, there are disclosed broad aspects of various exemplary embodiments.

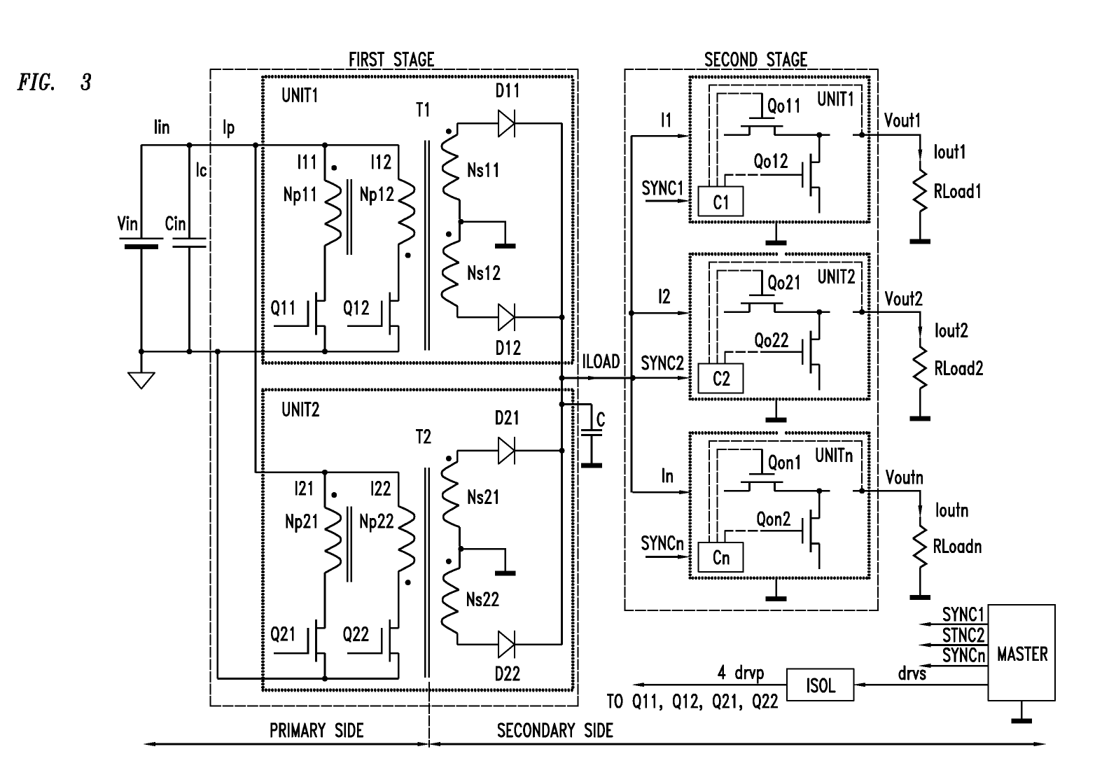

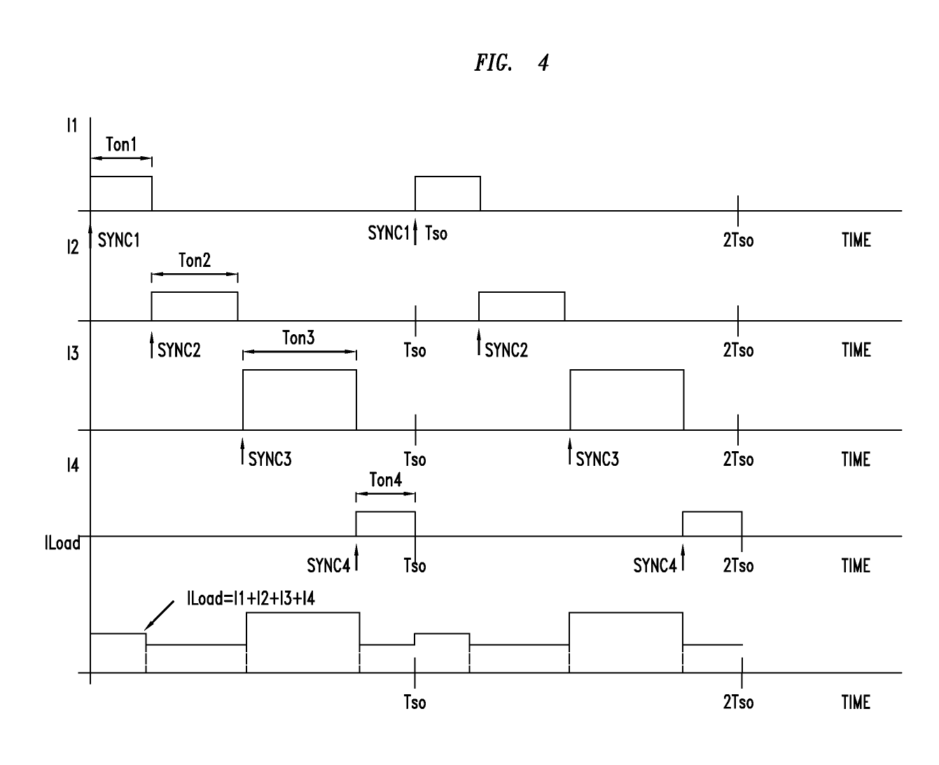

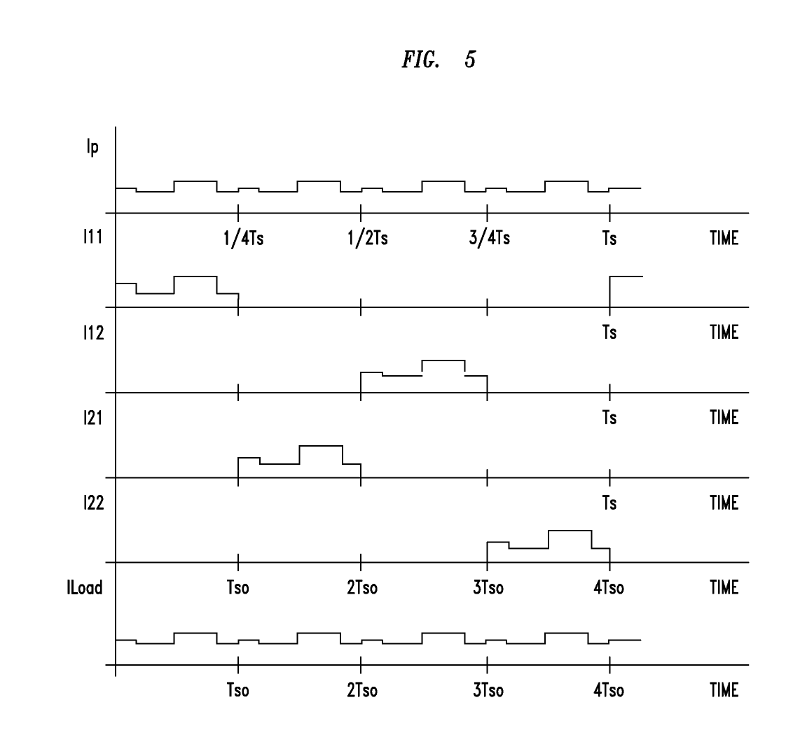

FIG. 3 illustrates an exemplary converter of the invention. This converter converts a DC input voltage Vin to multiple DC output voltages Vout1 through Voutn. Load resistors RLoad1 through RLoadn are connected to the outputs developing load currents Iout1 through Ioutn. Front-end capacitor Cin is a local decoupling capacitor providing a low impedance source of energy for transformers T1 and T2. The converter's first stage provides an isolation function. Current flowing out of the first-stage ILoad is referred to here as the first-stage load current. Depending on the second-stage input currents I1 through In, several types of first-stage load current waveforms may be created. These waveforms are shown in FIG. 4 through FIG. 11. The first stage may include first and second power conversion units Unit1 and Unit2, the first power conversion unit having transformer T1, primary side switches Q11, and Q12, and secondary switches D11 and D12; and the second power conversion unit having transformer T2, primary side switches Q21 and Q22, and secondary switches D21 and D22. The transformer turn ratio between the primary windings in this embodiment may be Np11:Np12:Np21:Np22=1:1:1:1, and the transformer turn ratio between the secondary windings may be Ns11:Ns12:Ns21:Ns22=1:1:1:1. The primary windings-to-secondary windings turn ratio may be any rational number which would be meaningful for any given practical application. As shown in FIGS. 5, 7, and 9, the two first-stage power conversion units operate using switching period Ts with a fixed duty cycle, each conduction branch conducting 25% of the converter switching period Ts.

The first-stage power conversion units may be implemented using any bridge topology converters such as push-pull, full-bridge or half-bridge.

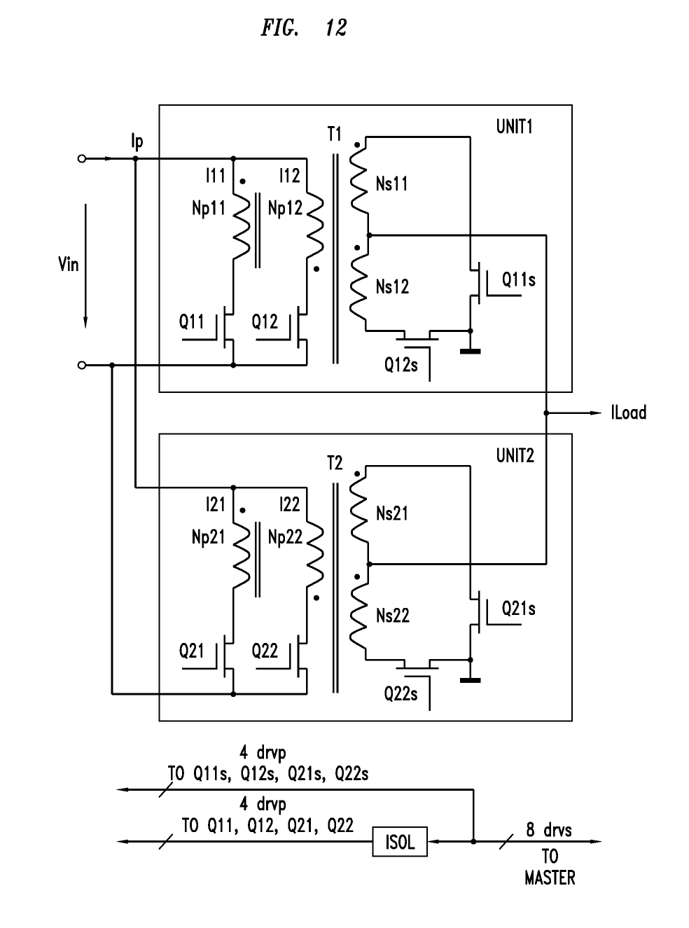

The exemplary converter of FIG. 3 operates using diode rectifiers D11, D12, D21, and D22 in the first stage, but the power converter's efficiency may be further improved by instead using switching MOS FET transistors. In this case, various driving schemes known to those skilled in the art may be used to control these transistors. FIG. 12 illustrates a circuit variant of the first stage and ISOL block of FIG. 3, where the diodes D11, D12, D21, and D22 are replaced by transistors Q11s, Q12s, Q21s, and Q22s while these transistors are driven by the Master control circuit. All other elements of FIG. 12 are similar and operate similarly to that of FIG. 3.

Referring to FIG. 3, the secondary stage consists of multiple power conversion units Unit1 through Unitn providing regulation for individual outputs Vout1 through Voutn. The output voltage Vout1 through Voutn of each unit Unit1 through Unitn is sensed and controlled by regulators C1 through Cn. In general, the switching period of the second-stage power conversion units Tso may be different than that in the first-stage power conversion units. For example, the switching period Tso may be set to be four times smaller than the switching period of the first-stage power conversion units, Ts. The second stage may include one or more power conversion units, the first power conversion unit having switching devices Qo11, and Qo12, the second through n power conversion units having switching devices Qo21 and Qo22 through Qon1 and Qon2, respectively.

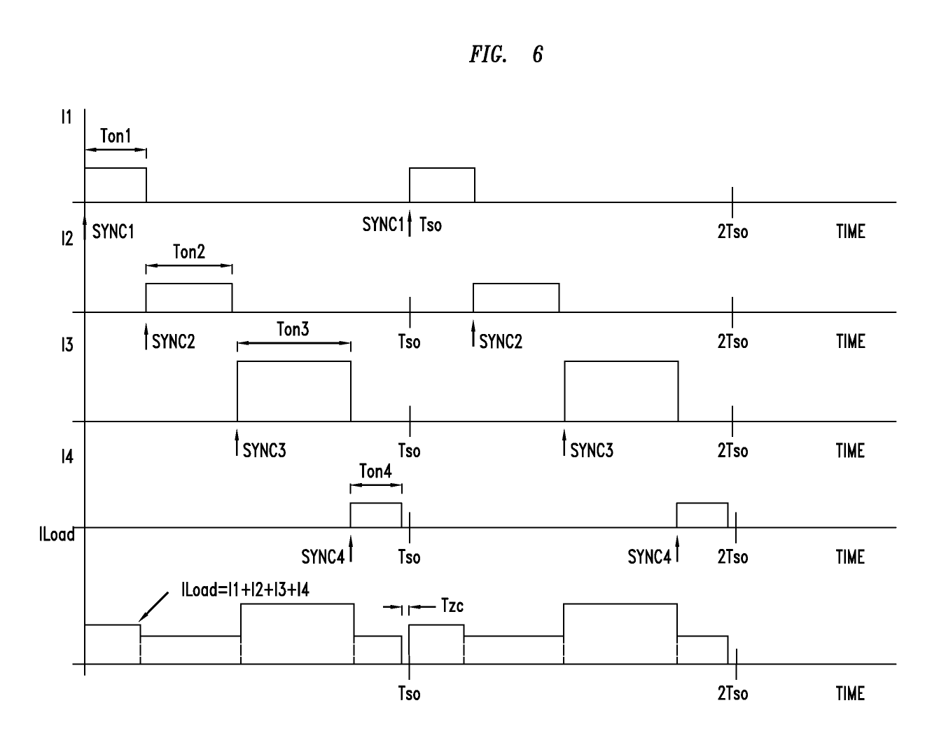

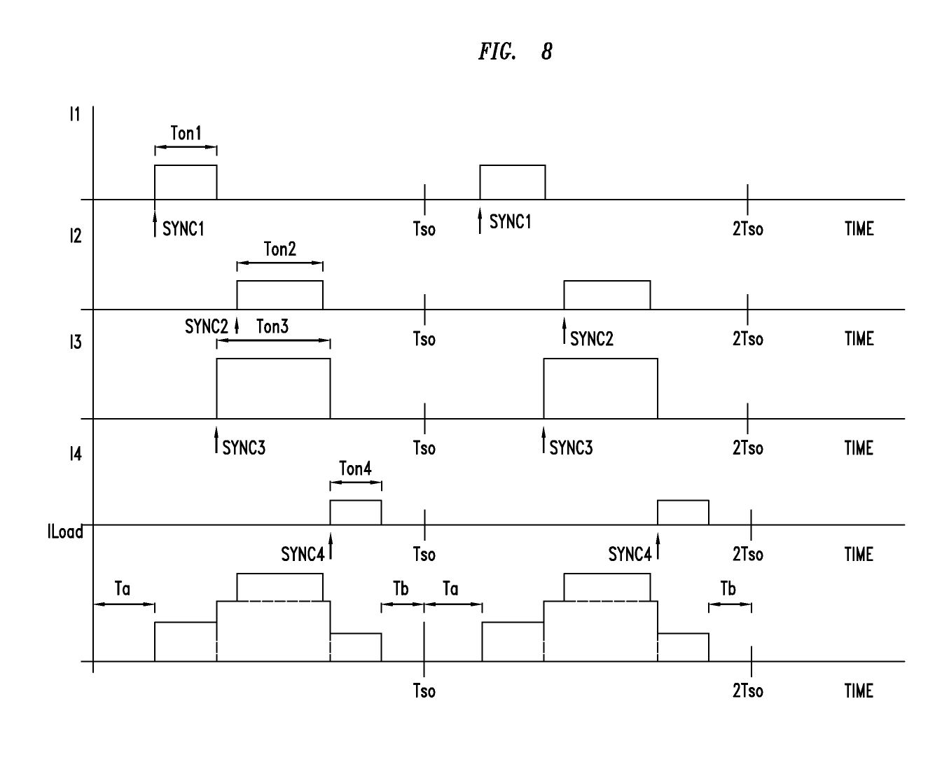

In the exemplary circuit of FIG. 3, the sum of on-time input currents of all secondary stage power conversion units I1 through In creates a load current ILoad to the primary stage power conversion units. For purposes of illustration, the exemplary waveforms for an arrangement having four second-stage power conversion units are depicted in FIG. 4, FIG. 6, and FIG. 8.

The second-stage power conversion units may be buck converters, boost converters, or converters of any other non-isolated topology.

Because the second-stage power conversion units are non-isolated topologies, the number of switching devices included is relatively small. A small number of switching devices results in low switching losses which facilitates using higher switching frequencies. An advantage of using higher switching frequency is that physically smaller lower cost magnetic devices may be used. For these reasons, switching frequency for the second-stage power conversion units may be set higher than the first-stage switching frequency.

In the exemplary circuit of FIG. 3 the Master control circuit resides on the converter's secondary side. The Master control circuit initiates i) synchronization signals sync1 through syncn for the second-stage power conversion units such that a desired waveform of the load current ILoad is achieved as well as ii) switch driving signals drys to drive the first-stage switches Q11 through Q22. The ISOL block provides primary side-to-secondary side coupling between the Master control circuit and the first-stage switches Q11 through Q22. The inputs to the ISOL block are the drys signals and outputs from the ISOL block are driving signals drvp.

Alternatively, the Master control circuit may reside on the converter's primary side. In such an arrangement, instead of transferring driving signals drys from the converter secondary side to the converter primary side, the ISOL block would transfer the synchronization signals sync1 through syncn from the converter primary side to the converter secondary side.

Master unit synchronization signals sync1, synod to syncn, and switch driving signals drys and drvp coordinate converter switching operation. As explained more fully below, synchronization may be set at the Master circuit depending on demand or application needs.

Capacitor C, placed between the converter first stage and second stage, provides filtering for any ringing which may occur during switching in the converter first stage. Alternatively, a series resistor to this capacitor C may be added to improve the filtering operation.

There are four conduction branches in the converter first stage. Each of them carries a branch current during one portion of switching period Ts. Each conduction branch consists of a primary side switch, primary winding, secondary side switch, and secondary winding, e.g. the first conduction branch carrying current I11 consists of switch transistor Q11, primary winding Np11, secondary side diode D11 and secondary winding Ns11, the second conduction branch carrying current I21 consists of switch transistor Q21, primary winding Np21, secondary side diode D21 and secondary winding Ns21, and so on with regards to the third branch carrying current I12 and the fourth branch carrying current I22. The Master control circuit can generate switching control signals drys such that each of the conduction branches caries current during equal time, i.e. each current branch conducts 25% of the first-stage switching period Ts. Further, the Master control circuit can generate control signals sync1 through syncn such that the second-stage power conversion units operate with switching period Tso which is four times smaller than the switching period of the first stage, such that 4×Tso=Ts as depicted in FIG. 4 through FIG. 9. With this arrangement, each conductive path in the converter first stage will carry the same current waveform leading to equal sharing of both the current and thermal stress between the first-stage power conversion units as well as preventing the first-stage unit from overloading due to current unbalance. Another advantage of this arrangement is that each conductive branch creates a path for the input current Tin to flow directly from the multi-output converter input voltage source Vin to the output of each second-stage unit Vout1 through Voutn without being stored by another energy storing device such as a capacitor or inductor. This way, number of components required for power conversion is reduced leading to component count reduction, lower costs, small physical size, and higher power conversion efficiency.

The sum of the on-time input currents generated by all second-stage power conversion units is equal to the first-stage load current. Therefore, the time when the second-stage unit begins its on-time interval is critical for shaping the first-stage load current. In general, factors which determine the shape of the first-stage load current include output voltages and currents of second-stage units, converter input voltage, the number of second-stage units, T1 and T2 transformer primary-to-secondary turn ratio, power conversion topologies used in the second stage, and timing of the switching control signals generated by the Master control circuit. Depending on all these factors, the Master control circuit can generate switching control signals such that requested waveform of first-stage load current ILoad is achieved. Several methods based on manipulation of design formulas known to those skilled in the art may be used to determine the timing of the switching control signals. As an illustrative example, synchronization times of the exemplary converter of FIG. 3. operating with the first-stage load current waveform depicted in FIG. 6 may be determined. In an alternative embodiment where four buck converters are deployed in the second stage, the Master control circuit may initiate synchronization times to the second-stage units tsync_1 as follows:

$$tsync\_i = {\sum }_{j = 1}^{i - 1} \frac{N p}{Ns} \frac{Tso}{Vin} Vout\_j$$

where index i stands for order of the second-stage unit, Np/Ns=1 is the transformer T1 and T2 primary-to-secondary turn ratio, and Vout_j is output voltage of j-th second-stage unit, while the synchronization time of Unit1 is zero, i.e. tsync_1=0.

Further, the Master control circuit will generate the switch driving signals such that the first-stage switches change their status during the zero current period Tzc. This may be accomplished by setting the switch driving times as follows: Ts/4-Tzc/2, Ts/2-Tzc/2, 3Ts/4-Tzc/2 and Ts−Tzc/2 where Ts=4×Tso and the zero current interval Tzc may be expressed as:

$$Tzc = Tso - {\sum }_{i = 1}^{4} \frac{N p}{Ns} \frac{Tso}{Vin} Vout\_i$$

In another example, the second-stage synchronization times may be computed as follows:

$$tsync\_i = \frac{i}{5} Tso - \frac{1}{2} \frac{N p}{Ns} \frac{Tso}{Vin} Vout\_i$$

To ensure the first-stage zero current switching, the timing of switch driving signal is: 0, Ts/4, Ts/2, and 3Ts/4. In this example, the middle point of the second-stage unit on-time interval would be spread evenly over the switching period Tso. The zero current interval Tzc may be expressed as:

$$Tzc = 2 Tso ( \frac{1}{5} - \frac{1}{4} \frac{N p}{Ns} \frac{Vout\_ 1 + Vout\_ 4}{Vin} )$$

As noted above, several types of exemplary first-stage load current waveforms can be generated by the Master control circuit. These waveforms are shown in FIG. 4 through FIG. 11. As shown in the examples, the load current may be continuous as shown in FIG. 4, the load current may include a small zero current period as shown in FIG. 6, and the load current may include a larger zero current period while its waveform is peaking approximately in the middle of switching period as shown in FIG. 8. In relation with the first stage arrangement described above, each of these waveforms has specific advantages for converter operation and performance. For instance, a switching arrangement of embodiment generating the load current waveform shown in FIG. 4 will allow continuous current to flow in the converter input section, completely eliminating first-stage cross-conduction problems while providing the benefit of small current ripple in the input section electrolytic capacitors and extending the lifetime of these capacitors as well as converter reliability. A circuit arrangement of the embodiment generating the load current waveform shown in FIG. 6 will allow temporary reduction of the first-stage current to zero proving an opportunity to switch the first-stage switches at zero current. Consequently, thermal stress across these switching devices is substantially reduced. Less thermal stress results in less cooling, higher reliability, and reduction of unwanted EMI noise while facilitating the use of substantially smaller filters in the power converter front end section, resulting in smaller size and lower cost. A circuit arrangement of the embodiment generating the load current waveform shown in FIG. 8 facilitates zero current switching in the first-stage units by extending the zero current interval.

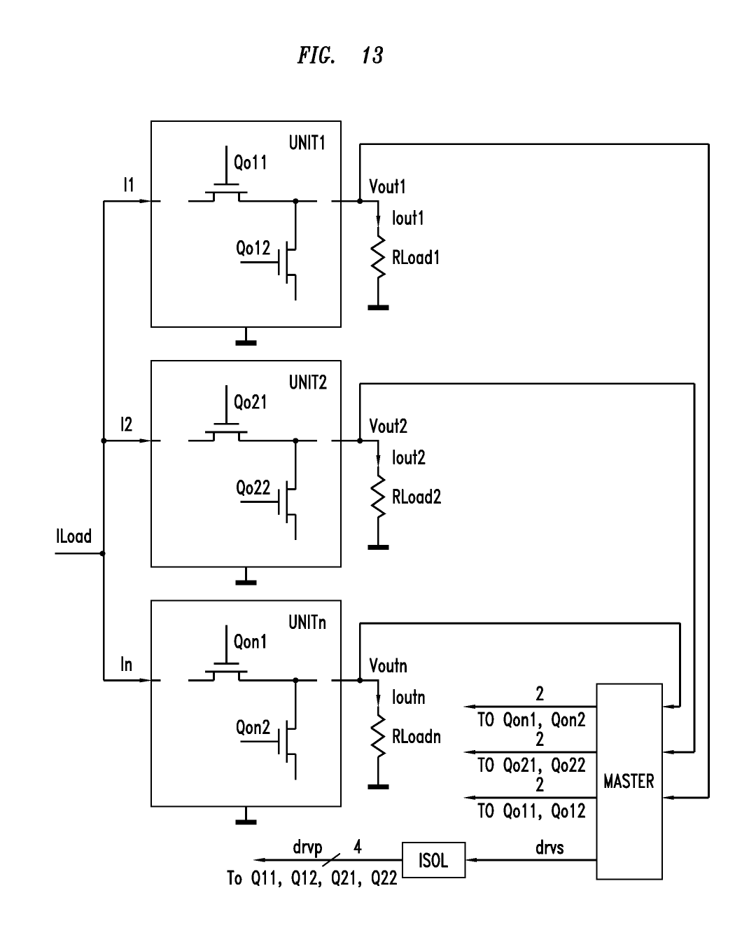

FIG. 13 depicts another arrangement of the second stage and Master control circuit of FIG. 3. With this arrangement, the Master control circuit, in addition to generating switch driving signals, also senses the second-stage output voltages and provides the output regulation function for the second-stage units. In this arrangement, the second-stage units do not include regulators. All other elements of FIG. 13 are similar and operate similarly to that of FIG. 3.

Time diagrams showing possible conduction times of the exemplary converter of FIG. 3 are shown in FIG. 4 and FIG. 5. In this example, the exemplary converter includes four second-stage power conversion units. FIG. 4 illustrates how the load current ILoad is composed of the on-time input currents of second-stage units 11 through 14, and FIG. 5 shows how this load current ILoad propagates through the first-stage conduction branches creating the converter input current Ip. At any time within switching period Ts, Ip=I11+I12+I21+I22. In this example, the Master control circuit generates synchronization signals sync1 through sync4 which, in turn, initiate on-time intervals for individual second-stage power conversion units. The sum of input currents of all secondary stage power conversion units I1 through I4 create load current ILoad to the first-stage power conversion units. It applies: ILoad=I1+I2+I3+I4. By setting the period of synchronization signals for individual second-stage power conversion units to Tso, the period of the second-stage operation is Tso as well. Further with this example, the conduction time of each of the first-stage conduction branches is set by the Master control circuit to be equal to the second-stage period Tso. Consequently, and to maintain equal current sharing among the first-stage conduction branches, the first-stage period is equal to four times the second-stage period, i.e. Ts=4×Tso. FIG. 5 depicts the first-stage load current ILoad, currents through the first-stage conduction branches I11, I12, I21, and I22, and converter input current Ip. In each of four switching phases of the converter first-stage, the load current ILoad is mapped to the converter input current Ip through the secondary-to-primary transformer ratio, generating essentially continuous input current Ip to the converter. For example, during the first time interval (0, Tso), switching devices Q11 and D11 are turned on allowing the load current ILoad to be delivered from the converter input Vin to the second-stage power units via transformer primary and secondary windings Np11 and Ns11. In the next time interval (Tso, 2Tso), switching devices Q21 and D21 are turned on allowing the load current ILoad to be delivered from the converter input Vin to the secondary stage power units via transformer primary and secondary windings Np21 and Ns21. In this example, the transformer T1 and T2 primary-to-secondary turn ratio is 1:1. Consequently, both the overall shape and magnitude of ILoad and Ip currents are the same. In an alternative embodiment where the T1 and T2 transformers also provide a step down function or a step up function, compared to the ILoad current the magnitude, the Ip current would be lower or higher respectively in proportion to the transformer T1 and T2 primary-to-secondary turn ratio.

Because each conduction branch in the converter first-stage conducts the current during a period of Ts/4=Tso of the same current waveform, components Q21, D21, Np21, Ns21 will carry the same current waveform as carried by components Q11, D11, Np11, Ns11 during the previous time interval. The power conversion procedure repeats similarly during intervals (2Tso, 3Tso) and (3Tso, 4Tso). Thus, all corresponding devices are stressed equally. An advantage of this arrangement is that the front-end capacitor Cin will bear a minimal amount of ripple current Ic, substantially reducing thermal stress on the capacitor Cin and increasing this capacitor's life time.

In practical application, time intervals Ton1 through Ton4 may slightly overlap or be set apart by small time intervals. This may show as small overshoots or undershoots on the converter input current (Ip) waveforms without harming the advantages coming from equal current sharing listed above.

Synchronization of the switching events between and within the first and second stages is central to achieving the advantages described above. In particular, the Master circuit may initiate switching at various times to create different types of load current waveforms. For example, the synchronization may be manipulated so the load current waveform is continuous and includes the smallest possible ripples, includes a small-current plateau, or includes a small interval where the load current is essentially zero. Note that in each of these exemplary cases equal current sharing within the first-stage power conversion units is maintained. Having the load current waveform include either a low current or zero current interval allows the Master circuit to initiate first-stage switching when the load current is the smallest or essentially zero, and therefore the first-stage switching devices will change their status while carrying minimum current. Changing status while carrying minimum current leads to substantial reduction of converter switching losses. This type of switching may be referred to as a low-current or zero current switching.

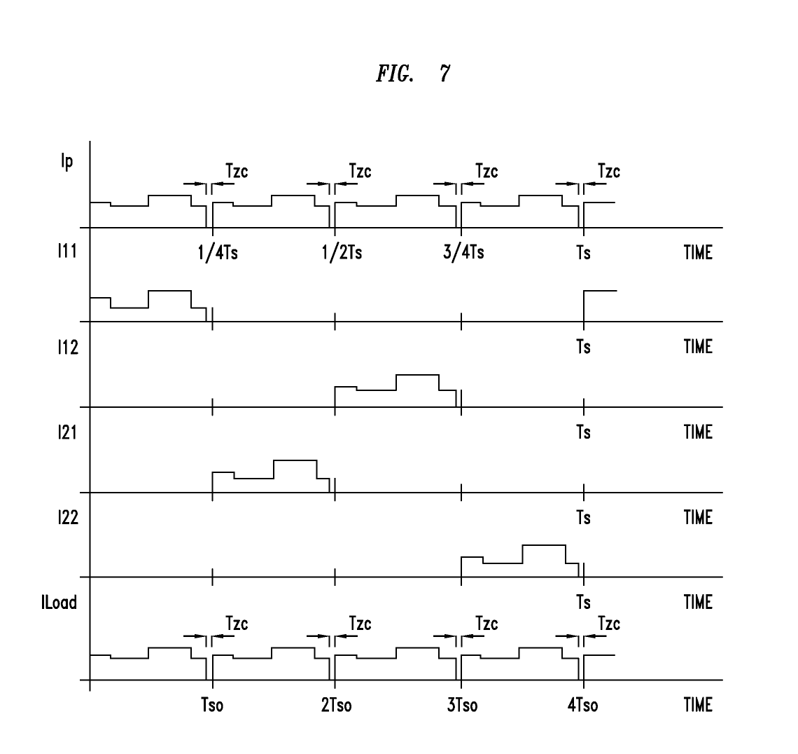

For example, time diagrams demonstrating exemplary non-resonant zero current switching of the invention are shown in FIG. 6 and FIG. 7. In this example, there are four second-stage power conversion units. As in FIGS. 4 and 5 above, FIG. 6 illustrates how the first-stage load current ILoad is composed using the on-time input currents of particular second-stage power conversion units I1 through I4, and FIG. 7 shows how this first-stage load current ILoad propagates through the first-stage conduction branches creating the converter input current Ip. At any time within switching period Ts, Ip=I11+I12+I21+I22. With this example, the Master control circuit generates synchronization signals sync1 through sync4 which, in turn, initiates on-time topologies for the individual second-stage power conversion units such that a load current waveform ILoad includes intervals Tzc where the load current is essentially zero. By having the zero current intervals included in the load current waveform, the Master circuit can initiate first-stage switching when the load current is zero. Consequently, the first-stage switching devices will change their status while carrying zero current. Similar to the previous example, the conduction time of each of the first conduction branches is set by the Master control circuit to be equal to the second-stage period Tso. Consequently, the first-stage period is equal to four times the second-stage period such that Ts=4×Tso. FIG. 7 depicts the first-stage load current ILoad, currents through the first-stage conduction branches I11, I12, I21, and I22, and converter input current Ip. Also with this switching arrangement, each conduction branch in the converter first-stage conducts the current during a period of Ts/4=Tso of the same current waveform, and components Q21, D21, Np21, Ns21 will carry the same current waveform as carried by components Q11, D11, Np11, Ns11 during the previous time interval. The power conversion procedure repeats similarly during intervals (2Tso, 3Tso) and (3Tso, 4Tso). Thus, all corresponding devices are stressed equally. Compared to the previous example, an additional advantage of this arrangement is that all switches included in the first stage will change their status while carrying zero current which leads to substantial reduction of converter switching losses, higher power conversion efficiency and substantial simplification of the converter cooling scheme.

It should be noted that in practical application time intervals Ton1 through Ton4 may often slightly overlap or be set apart by small time intervals. This may show as small overshoots or undershoots on the converter input current (Ip) waveforms without harming the advantages coming from equal current sharing as well as those from zero current switching.

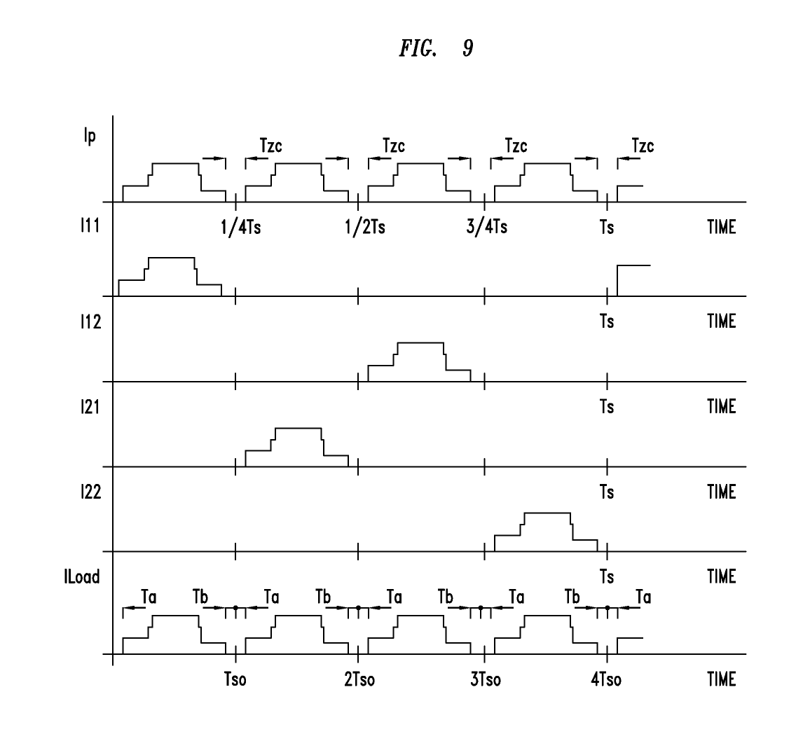

Time diagrams showing conduction times of the exemplary converter of FIG. 3 using another synchronization arrangement are shown in FIG. 8 and FIG. 9. In this arrangement, the zero current time interval is increased to facilitate zero current switching. Specifically, FIG. 8 illustrates how the synchronization signals sync1 through sync4 are arranged to create time intervals Ta and Tb on waveform of load current ILoad. FIG. 9 shows how the load current ILoad propagates through the first-stage conduction branches creating the converter input current Ip. At any time within switching period Ts, Ip=I11+I12+I21+I22. Because the first-stage switches change their status regularly at the beginning, ¼, ½, and ¾ of each switching period Ts, the zero current switching headroom before the switching instant is Ta and zero switching headroom after the switching instant is Tb making the total zero current interval to be equal to the sum of the intervals Ta and Tb, i.e. Tzc=Ta+Tb. For illustration purposes, the number of second-stage power conversion units was set to four.

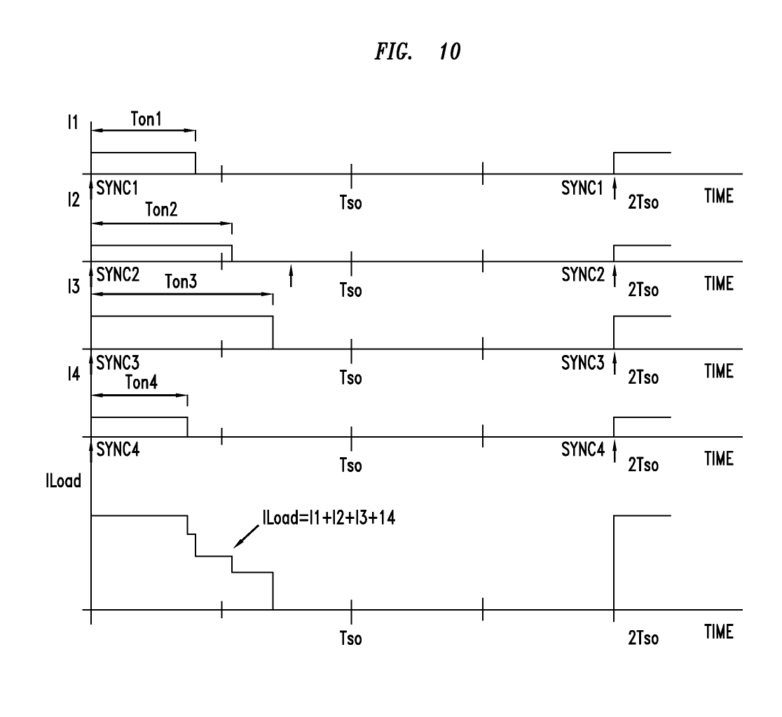

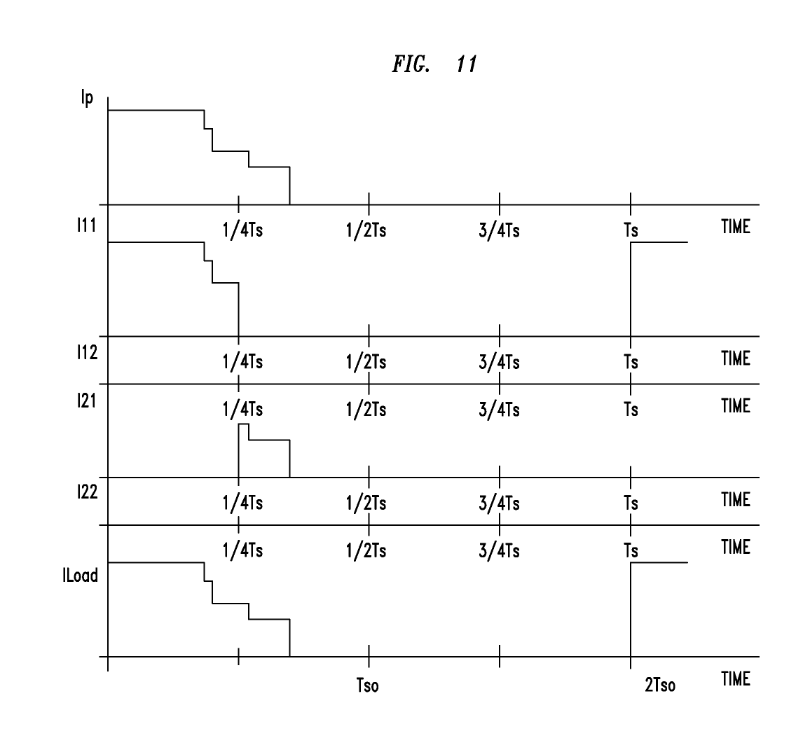

In contrast to the embodiments of the invention, FIG. 10 and FIG. 11 demonstrate an example of poor switching coordination between power conversion units leading to power flow unbalance as well as undesired high-current switching. For illustration purposes, the number of second-stage power conversion units was set to four. In this example, Ts/2=Tso, and all second-stage units start the on-time topology at the same time. As a consequence, components Q21, D21, Np21, Ns21 carry moderate current but components Q11, D11, Np11, Ns11 carry maximum current while components Q12, D12, Np12, Ns12, Q22, D22, Np22, Ns22 do not carry load current at all. Consequently, switching devices Q11, D11 and transformer T1 will be overloaded. In this configuration, the front-end input capacitor Cin will bear significantly high ripple current which will lead to its temperature increase and shorter life time.

The multi-output power converter of the invention should preserve energy and reduce costs for power conversion, as well as operate more coolly, efficiently and reliably while processing more power in a more compact device, by reducing power losses, ripple currents and ripple voltages across converter components.

It should be apparent that the power converter of the invention may be combined with other elements such as short-circuit protection circuits, overload protection circuits, power signal indicator, etc. within a power converter. Furthermore, the power converter may be applied in other systems that require power conversion. Some hardware applications may require the use of multiple power converters of the embodiment described herein.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A power conversion device, comprising:
an input configured to receive input power;
a first-stage circuit connected to the input configured to provide galvanic isolation between the input and a second-stage circuit, wherein the first-stage circuit comprises
at least one first-stage power conversion unit, each first-stage power conversion unit comprising at least two primary switches, at least two secondary diode switches, and an isolation transformer comprising
a primary winding, and
a secondary winding;
the second-stage circuit connected to an output of the first-stage circuit, the second-stage circuit comprising at least one second-stage power conversion unit configured to regulate the voltage to at least one output connected to a load, each at least one second-stage power conversion unit comprising a controller;
a master circuit connected to the at least one controller, the master circuit configured to synchronize switching in the at least one second-stage power conversion unit; and
wherein the master circuit is configured to drive the primary switches in the at least one first-stage power conversion unit.

2. The power conversion device of claim 1, wherein each of the at least one second-stage power conversion unit is one of the group consisting of a buck converter and a boost converter.

3. The power conversion device of claim 1, wherein each of the at least one first-stage power conversion unit is one of the group consisting of a push-pull converter, full-bridge converter, and a half-bridge converter.

4. The power conversion device of claim 1, wherein the master circuit is configured to switch the second-stage power conversion units such that the first-stage load current is an essentially continuous waveform having a period.

5. The power conversion device of claim 1, wherein the master circuit is configured to switch the second-stage power conversion units such that the first-stage load current includes intervals where the load current is essentially zero.

6. The power conversion device of claim 1, wherein the master circuit is configured to switch the second-stage power conversion units such that the first-stage load current includes intervals of substantial length where the first-stage load current is essentially zero.

7. The power conversion device of claim 1, wherein the master circuit is ground referenced to a primary side or a secondary side of the power conversion device.

8. The power conversion device of claim 1, wherein the isolation transformer provides a step up or step down function.

9. A power conversion device, comprising:
an input configured to receive input power;
a first-stage circuit connected to the input configured to provide galvanic isolation between the input and a second-stage circuit, wherein the first-stage circuit comprises
at least one first-stage power conversion unit, each first-stage power conversion unit comprising at least two primary switches, at least two secondary transistor switches, and an isolation transformer comprising
a primary winding, and
a secondary winding;
the second-stage circuit connected to an output of the first-stage circuit, the second-stage circuit comprising at least one second-stage power conversion unit configured to regulate the voltage to at least one output connected to a load, each at least one second-stage power conversion unit comprising a controller;
a master circuit connected to the at least one controller, the master circuit configured to synchronize switching in the at least one second-stage power conversion unit; and
wherein the master circuit is configured to drive the primary switches and the secondary transistor switches in the at least one first-stage power conversion unit.

10. The power conversion device of claim 9, wherein each of the at least one second-stage power conversion unit is one of the group consisting of a buck converter and a boost converter.

11. The power conversion device of claim 9, wherein each of the at least one first-stage power conversion unit is one of the group consisting of a push-pull converter, full-bridge converter, and a half-bridge converter.

12. The power conversion device of claim 9, wherein the master circuit is configured to switch the second-stage power conversion units such that the first-stage load current is an essentially continuous waveform having a period.

13. The power conversion device of claim 9, wherein the master circuit is configured to switch the second-stage power conversion units such that the first-stage load current includes intervals where the load current is essentially zero.

14. The power conversion device of claim 9, wherein the master circuit is configured to switch the second-stage power conversion units such that the first-stage load current includes intervals of substantial length where the first-stage load current is essentially zero.

15. A power conversion device, comprising:
an input configured to receive input power;
a first-stage circuit connected to the input configured to provide galvanic isolation between the input and a second-stage circuit, wherein the first-stage circuit comprises
at least one first-stage power conversion unit, each first-stage power conversion unit comprising at least two primary switches, at least two secondary diode switches, and an isolation transformer comprising
a primary winding, and
a secondary winding;
the second-stage circuit connected to an output of the first-stage circuit, the second-stage circuit comprising at least one second-stage power conversion unit;
a master circuit connected to the at least one second-stage power conversion unit, the master circuit configured to drive the second-stage switches and regulate the output of the at least one second-stage power conversion unit; and
wherein the master circuit is configured to drive the primary switches in the at least one first-stage power conversion unit.

16. The power conversion device of claim 15, wherein each of the at least one second-stage power conversion unit is one of the group consisting of a buck converter and a boost converter.

17. The power conversion device of claim 15, wherein each of the at least one first-stage power conversion unit is one of the group consisting of a push-pull converter, full-bridge converter, and a half-bridge converter.

18. The power conversion device of claim 15, wherein the master circuit is configured to switch the second-stage power conversion units such that the first-stage load current is an essentially continuous waveform having a period.

19. The power conversion device of claim 15, wherein the master circuit is configured to switch the second-stage power conversion units such that the first-stage load current includes intervals where the load current is essentially zero.

20. The power conversion device of claim 15, wherein the master circuit is configured to switch the second-stage power conversion units such that the first-stage load current includes intervals of substantial length where the first-stage load current is essentially zero.
